(19) United States
(12) Patent Application Publication
(10) Pub. No.: US 2015/0339028 A1
(43) Pub. Date: Nov. 26, 2015

(54) Responding to User Input Gestures

(71) Applicant: NOKIA TECHNOLOGIES OY, Espoo (FI)

(72) Inventors: Zhi CHEN, Beijing (CN); Yunjian ZOU, Beijing (CN); Yuyang LIANG, Beijing (CN); Chang LIU, Beijing (CN); Bin GAO, Beijing (CN)

(21) Appl. No.: 14/758,217

(22) PCT Filed: Dec. 28, 2012
(86) PCT No.: PCT/CN2012/087856

§ 371 Date: Jun. 26, 2015

(51) Int. Cl. G06F 3/0488; G06F 3/0484

(52) U.S. Cl. CPC G06F 3/0488; G06F 3/0484

(57) ABSTRACT

Apparatus comprises at least one processor, and at least one memory, having computer-readable code stored thereon, the at least one memory and the computer program code being configured to, with the at least one processor, cause the apparatus to disable touch-sensitivity of a first touch-sensitive region, to enable touch-sensitivity of a second touch-sensitive region, and to be responsive to receipt, while the touch-sensitivity of the first touch-sensitive region is disabled, of a user input gesture, at least part of which is in respect of the second touch-sensitive region, to cause a graphical user interface to be displayed on a display panel, wherein the first and second touch-sensitive regions are configured to detect at least one type of touch input gesture and are configured such that the touch-sensitivities of the first and second touch sensitive regions are independently controllable.

### FIELD

Embodiments of the invention relate to responding to user input gestures.

In particular, but not exclusively, some embodiments relate to providing notification information responsive to user input gestures.

In particular, but not exclusively, some embodiments further relate to providing notification information responsive to user-input gestures when notifications are received on electronic apparatus operating in a state which has disabled a part of its user interface so that user input which otherwise be provides access to such notification information in at least one other state of the electronic apparatus is no longer sensed and/or responded to.

### BACKGROUND

Modern touchscreen devices can be unlocked in a number of different ways. Many of these include the provision of some form of dynamic touch input on the touchscreen.

### SUMMARY

In an embodiment of a first aspect, this specification describes apparatus comprising: at least one processor; and at least one memory, having computer-readable code stored thereon, the at least one memory and the computer program code being configured to, with the at least one processor, cause the apparatus: to disable touch-sensitivity of a first touch-sensitive region; to enable touch-sensitivity of a second touch-sensitive region; and to be responsive to receipt, while the touch-sensitivity of the first touch-sensitive region is disabled, of a user input gesture, at least part of which is in respect of the second touch-sensitive region, to cause a graphical user interface to be displayed on a display panel, wherein the first and second touch-sensitive regions are configured to 3o detect at least one type of touch input gesture and are configured such that the touch-sensitivities of the first and second touch sensitive regions are independently controllable.

The at least one memory and the computer program code may be configured to, with the at least one processor, cause the apparatus to disable the display panel, wherein the user input gesture is initiated while the display panel is disabled.

The at least one memory and the computer program code may be configured to, with the at least one processor, cause the apparatus to be responsive to the receipt of the user input gesture to enable the touch-sensitivity of the first touch-sensitive region. The at least one memory and the computer program code may be configured to, with the at least one processor, cause the apparatus to determine a type of the user input gesture; and to enable the touch-sensitivity of the first touch-sensitive region only if the determined type matches a predefined type.

The graphical user interface may be caused to be displayed on the display panel while the touch-sensitivity of the first touch-sensitive region is disabled.

The at least one memory and the computer program code may be configured to, with the at least one processor, cause the apparatus to enable the touch sensitivity of the second touch-sensitive region in response to the detection of an occurrence of an event. The graphical user interface may be associated with the event. The event may comprise receipt by the apparatus of a communication from a remote device. The graphical user interface may be associated with the received communication and may include content contained in the received communication. The at least one memory and the computer program code may be configured to, with the at least one processor, cause the apparatus to be responsive to occurrence of the event to cause a visual notification module to provide a visual notification regarding the event to a user. The at least one memory and the computer program code may be configured to, with the at least one processor, cause the apparatus to cause the visual notification module to become illuminated, thereby to provide the visual notification to the user. The visual notification module may comprise at least one light emitting diode. A colour in which the visual notification is provided may be dependent upon a type of the event.

The at least one memory and the computer program code may be configured to, with the at least one processor, cause the apparatus to determine a location within the second touch-sensitive region in respect of which the part of the user input gesture was received, and to select the graphical user interface for display from a plurality of graphical user interfaces based on the determined location within the second touch-sensitive region.

The at least one memory and the computer program code may be configured to, with the at least one processor, cause the apparatus to determine a type of the user input gesture, and to select the graphical user interface for display from a plurality of graphical user interfaces based on the determined type of the user input gesture.

The apparatus may comprise the first touch-sensitive region, and the second touch sensitive region. The first and second touch sensitive regions may be regions of a continuous surface. The apparatus may comprise the display panel, and the first touch-sensitive region may overlie the display panel and the second touch-sensitive region of the touch-sensitive panel may be located outside a perimeter of the display panel. The apparatus may further comprise a visual notification module and the second touch-sensitive region may overlie the visual notification module.

The user input gesture comprises a swipe input, the swipe input moving from the second touch-sensitive region to the first touch sensitive region.

The apparatus may be a device and the first and second touch-sensitive regions may be provided on different faces of the device. The first and second touch-sensitive regions may be provided on opposite faces of the device.

The user input gesture may comprise a touch input in respect of the second touch-sensitive region, the touch input in respect of the second touch-sensitive region having a duration in excess of a threshold duration.

The user input gesture may comprise a sequence of user inputs.

One or both of the first and second touch-sensitive regions may be configured to detect plural different types of user input gesture.

In an embodiment of a second aspect, this specification describes a method comprising: disabling touch-sensitivity of a first touch-sensitive region; enabling touch-sensitivity of a second touch-sensitive region, the first and second touch-sensitive regions being configured to detect at least one type of touch input gesture and being configured such that touch-sensitivities of the first and second touch sensitive regions are independently controllable; and responding to receipt, while the touch-sensitivity of the first touch-sensitive region is disabled, of a user input gesture, at least part of which is in respect of the second touch-sensitive region, by causing a graphical user interface to be displayed on a display panel.

The method may comprise disabling the display panel, wherein the user input gesture is initiated while the display panel is disabled. The method may comprise responding to the receipt of the user input gesture by enabling the touch-sensitivity of the first touch-sensitive region. The method may comprise determining a type of the user input gesture, and enabling the touch-sensitivity of the first touch-sensitive region only if the determined type matches a predefined type.

The method may comprise causing the graphical user interface to be displayed on the display panel while the touch-sensitivity of the first touch-sensitive region is disabled.

The method may comprise enabling the touch sensitivity of the second touch-sensitive region in response to the detection of an occurrence of an event. The graphical user interface may be associated with the event. The event may comprise receipt by the apparatus of a communication from a remote device. The graphical user interface may be associated with the received communication and may include content contained in the received communication. The method may comprise responding to the occurrence of the event by causing a visual notification module to provide a visual notification regarding the event to a user. The method may comprise causing the visual notification module to become illuminated, thereby to provide the visual notification to the user. The visual notification module may comprise at least one light emitting diode. A colour in which the visual notification is provided may be dependent upon a type of the event.

The method may comprise determining a location within the second touch-sensitive region in respect of which the part of the user input gesture was received, and selecting the graphical user interface for display from a plurality of graphical user interfaces based on the determined location within the second touch-sensitive region. The method may comprise determining a type of the user input gesture, and selecting the graphical user interface for display from a plurality of graphical user interfaces based on the determined type of the user input gesture.

The user input gesture may comprise a swipe input, the swipe input moving from the second touch-sensitive region to the first touch sensitive region.

The user input gesture may comprise a touch input in respect of the second touch-sensitive region, the touch input in respect of the second touch-sensitive region having a duration in excess of a threshold duration.

The user input gesture may comprise a sequence of user inputs.

One or both of the first and second touch-sensitive regions may be configured to detect plural different types of user input gesture.

In an embodiment of a third aspect, this specification describes at least one non-transitory computer-readable memory medium having computer-readable code stored thereon, the computer-readable code being configured to cause computing apparatus: to disable touch-sensitivity of a first touch-sensitive region; to enable touch-sensitivity of a second touch-sensitive region, the first and second touch-sensitive regions being configured to detect at least one type of touch input gesture and being configured such that touch-sensitivities of the first and second touch sensitive regions are independently controllable; and to be responsive to receipt, while the touch-sensitivity of the first touch-sensitive region is disabled, of a user input gesture, at least part of which is in respect of the second touch-sensitive region, to cause a graphical user interface to be displayed on a display panel.

In an embodiment of a fourth aspect, this specification describes computer-readable code, optionally stored on at least one non-transitory memory medium, which, when executed by computing apparatus, causes the computing apparatus to perform any method described with reference to the second aspect.

In an embodiment of a fifth aspect this specification describes apparatus comprising: means for disabling touch-sensitivity of a first touch-sensitive region; means for enabling touch-sensitivity of a second touch-sensitive region, the first and second touch-sensitive regions being configured to detect at least one type of touch input gesture and being configured such that touch-sensitivities of the first and second touch sensitive regions are independently controllable; and means for responding to receipt, while the touch-sensitivity of the first touch-sensitive region is disabled, of a user input gesture, at least part of which is in respect of the second touch-sensitive region, by causing a graphical user interface to be displayed on a display panel.

The apparatus may further comprise means for performing any of the operations or steps described with reference to the second aspect.

### BRIEF DESCRIPTION OF THE FIGURES

For a more complete understanding of embodiments of the present invention, reference is now made to the following description taken in connection with the accompanying drawings, which are by way of example only and in which:

FIG. 1 is a schematic depiction of an example of apparatus according to embodiments of the invention;

FIG. 2 is a schematic illustration of a system in which the apparatus of FIG. 1 may be deployed;

FIG. 3 is simplified plan view of an example of a device including the apparatus of FIG. 1;

FIGS. 4A to 4C illustrate examples of operations that may be performed by the apparatus of FIG. 1;

FIG. 5 is a flow chart illustrating an example of a method that may be performed by the apparatus of FIG. 1;

FIG. 6 is a schematic illustration of an example of a notification module which may be included in the apparatus of FIG. 1; and

FIGS. 7A to 7C and 8A to 8C illustrate examples of operations that may be performed by the apparatus of FIG. 1; and

FIG. 9 is a flow chart illustrating an example of a method that may be performed by the apparatus of FIG. 1.

### DETAILED DESCRIPTION OF SOME EXAMPLES OF EMBODIMENTS

The accompanying figures show schematically embodiments of the invention which are by way of example only in that one or more of the structural elements shown in the drawings may have functional equivalents which are not shown or described explicitly herein but which would nonetheless be apparent as suitable alternative structures or functional equivalents to a person of ordinary and unimaginative skill in the art. In some instances, structures and/or functionality used by some embodiments of the invention may be omitted from the drawings and/or description if their inclusion is well known to anyone of ordinary but unimaginative skill in the art and/or if a description of such structures/functionality is unnecessary for understanding the workings of the embodiments of the invention, or the inclusion of such functionality and/or structures in the drawings and/or description would result in a loss of clarity.

In the description and drawings, like reference numerals refer to like elements throughout.

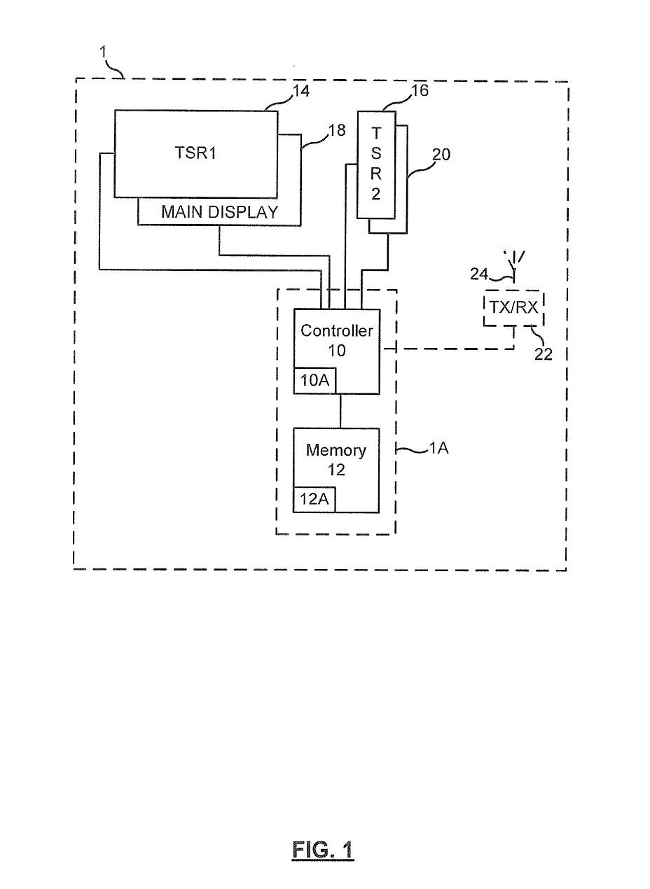

FIG. 1 is a schematic depiction of an example of apparatus 1 according to various embodiments of the invention. The apparatus 1 comprises control apparatus 1A. The control apparatus 1A comprises a controller 10 and at least one memory medium 12. The controller 10 is configured to read data from the memory 12 and also to write data, either temporarily or permanently, into the memory 12. The controller 10 comprises at least one processor or microprocessor 10A coupled to the memory 12. The controller 10 may additionally comprise one or more application specific integrated circuits (not shown).

The memory 12 may comprise any combination of suitable types of volatile or non-volatile non-transitory memory 12 media. Suitable types of memory 12 include, but are not limited to, ROM, RAM and flash memory 12. Stored on one or more of the at least one memory 12 is computer-readable code 12A (also referred to as computer program code). The at least one processor 10A is configured to execute the computer-readable code 12A. The at least one memory 12 and the computer program code 12A are configured to, with the at least one processor 10A, control the other components of the apparatus 1. More generally, the at least one memory 12 and the computer program code 12A are configured to, with the at least one processor 10A, cause the control apparatus 1A to perform a number of operations.

In some examples of embodiments of the invention, the apparatus 1 comprises a plurality of touch-sensitive regions 14, 16. The term “touch-sensitive” refers to the capability to detect the presence of an input element (such as, for example, a user's finger or a stylus) on the region (which also may be referred to as a touch-sensitive surface). The capability may be provided by any suitable type of technology. Such technology includes, but is not limited to, resistive touch-sensitive panels, capacitive touch-sensitive panels and optical touch-sensitive panels. Capacitive touch-sensitivity may be implemented in any suitable way. Optical touch sensitivity may be provided by, for example, an optical detector (such as a camera, an infra-red sensor, a light sensor or a proximity sensor) provided beneath the surface/region and configured to detect the presence of an input element on the surface. Certain touch-sensitive technologies are operable also to detect the presence of an input element above the region or surface. This type of input is known as a “hover input”. The term “user input gesture in respect of a touch-sensitive region” as used herein should be understood to include both a touch input (i.e. physical contact between an input element and the touch-sensitive region or surface 14, 16) and a hover input.

A user input gesture may include a static or dynamic user input or a combination of the two. A static user input is one in which the user input element is in contact with or is directly above a single location on the touch-sensitive region. A dynamic user input is one in which the user input element is moved across, or just above and parallel to, the touch-sensitive region.

In the example of FIG. 1, the apparatus 1 comprises a first touch-sensitive region 14 which is independently controllable by the controller 10. Additionally, the apparatus 1 comprises a second touch-sensitive region 16, which is also independently controllable by the controller 10. The first and second touch-sensitive regions 14, 16 are independently controllable in that the touch-sensitivity of the first and second touch sensitive regions 14, 16 can be enabled and disabled (or activated and deactivated) independently of one another. The touch-sensitivity of the regions 14, 16 is enabled, or active, when the touch-sensitive region and associated touch-sensing circuitry are active, for example, if they are provided with power (or are switched on). If the touch-sensitive region and associated circuitry are not active (due to either no power being provided or to a setting disabling the touch-sensitivity of the region being active), the touch-sensitive region will not be in a state in which it is able to detect user inputs provided thereto. Accordingly, if touch-sensitivity is disabled, the controller 10 does not receive any signals from the touch-sensitive region when a user input gesture occurs in respect of that region. Put another way, touch-sensitivity being disabled does not include the controller 10 simply disregarding signals received from the touch-sensitive region 14, 16.

The controller 10 is operable to determine a location or locations of a user input gesture on the first touch-sensitive region 14 based on signals received therefrom. In some examples, the controller so may be operable also to determine a location or locations of a user input gesture on the second touch-sensitive region 16. In other examples, the controller 10 may be operable only to determine that at least part of a user input gesture is within the second touch sensitive region 16, but may not be operable to determine the location of the part of the user input gesture that is within the second touch-sensitive region 16.

The first and second touch-sensitive regions 14, 16 may utilise the same or different types of touch detection technology. In some specific examples, both of the first and second touch sensitive regions 14, 16 may utilise capacitive touch-detection technology. In other examples, the first touch-sensitive region 14 may be a capacitive touch-sensitive region and the second touch-sensitive region may utilise optical touch detection technology (such as a proximity sensor, light sensor, or a camera module) to detect user inputs in respect of the second touch sensitive region 16.

In some examples, the first and second touch-sensitive regions 14, 16 may be different regions of a continuous surface. For example, the first and second-touch sensitive regions 14, 16 may be integrated into a single (for example, capacitive) touch-sensitive panel but may be configured, together with the controller 10, such that they are independently controllable. In other examples, the first and second touch-sensitive regions 14, 16 may be separate or discrete touch-sensitive modules or panels. The touch sensitive panels 14, 16 and associated display regions 18, 20 may be provided on the same or opposite sides of apparatus 1.

The apparatus 1 further comprises a main display panel 18. The main display panel 18 is configured, under the control of the controller 10, to provide images for consumption by the user. The controller 10 is operable also to disable or deactivate the main display panel 18. When the main display panel 18 is disabled, no images are displayed. Put another way, the controller 10 may be operable to switch off the display panel. When the display panel 18 is switched off/disabled, the display panel 18 may be said to be in sleep mode.

The main display panel 18 may be of any suitable type including, but not limited to LED and OLED. The first touch-sensitive region 14 is provided in register with the main display panel 18. As such, the first touch sensitive region 14 and the main display panel form a “touchscreen”. In some examples, such as in which the first touch-sensitive region 14 is a capacitive touch sensitive panel, this may include the first touch-sensitive region 14 overlying the main display panel 18. In such examples, when the first touch sensitive region 14 is disabled, the touchscreen 18, 14 may be said to be “locked”.

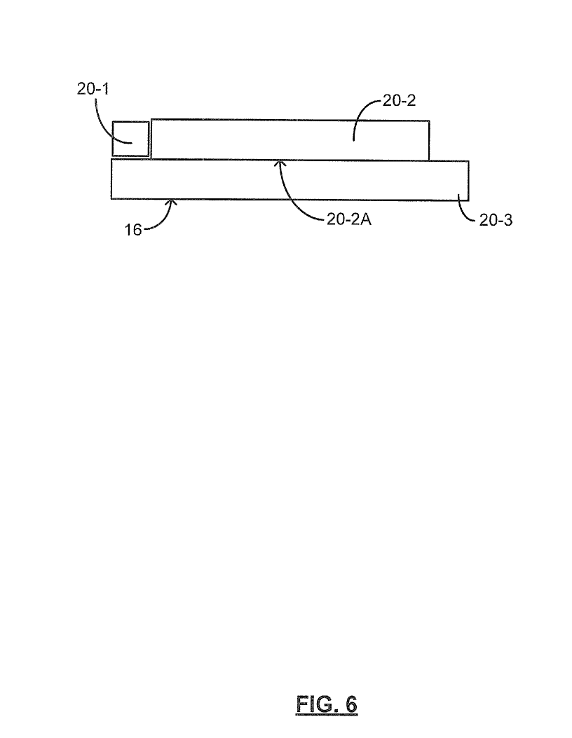

The apparatus 1 may also include a visual notification module 20, such as the example shown schematically in FIG. 6. The visual notification module 20 is configured, under the control of the controller 10, to provide visual notifications (or alerts) to the user of the apparatus 1. The controller 10 may cause the visual notifications to be provided to the user the user in response to the occurrence of an event. More specifically, the controller 10 may cause the visual notifications to be provided to the user in response to receipt of a communication from a remote device or apparatus. The communication may be, for example, a telephone call, a voicemail, an email, an SMS, an MMS or an application message or notification received from a server. Additionally or alternatively, the controller 10 may be configured to cause the visual notification module 20 to provide visual notifications in response to events that are internal to the apparatus 1. Such events may include, but are not limited to, calendar application reminders and battery manager notifications.

In some examples, the second touch-sensitive region 16 may be in register with the visual notification module 20. In this way, visual notifications which are provided by the module 20 are visible through the second touch-sensitive region 16. The visual notification module 20 may comprise at least one light emitting diode (LED). The controller 10 may cause at least one of the at least one LED to become illuminated, thereby to provide the visual notification to the user. The use of an LED is an energy efficient way to notify the user that an event has occurred. The visual notification module 20 may be operable to be illuminated in one of plural different colours. In such examples, the controller 10 may be operable to select the colour based on the type of event which has occurred. For example, the controller 10 may select a different colour for each of a missed SMS, a missed call, a missed alert from an application and a multiple-event report. For example, the visual notification module 20 may comprise an RGB LED. As such, the module 20 may be operable to be illuminated in red, green, blue and white. In such examples, the colour green may be used to indicate a received SMS, the colour red may be used to indicate a missed voice communication and the colour blue may be used to indicate an application notification. The colour white may be used if more than one event has occurred.

In some examples of the invention, the apparatus 1 may also comprise at least one transceiver module 22 and an associated antenna 24. The at least one transceiver module 22 and the antenna 24 may be configured to receive communications (such as those discussed above) from a remote device or apparatus. Communications received via the transceiver module 22 and antenna may be transferred to the controller 10 for processing. The controller to may also cause communications to be transmitted via the at least one transceiver module 20 and associated antenna 24. The at least one transceiver module 22 and antenna 24 may be configured to operate using any suitable type or combination of types of wired or wireless communication protocol. Suitable types of protocol include, but are not limited to 2G, 3G, 4G, WiFi, Zigbee and Bluetooth.

In some examples of embodiments of the invention, the controller 10 is configured to cause the second touch-sensitive region 16 to remain, or to become, touch-sensitive while the first touch-sensitive region 16 is deactivated. The controller 10 is then responsive to a receipt of a user input gesture, at least part of which is in respect of the activated second touch-sensitive region 16, to cause a graphical user interface to be displayed on the main display panel 18. As such, examples of the invention enable a user to selectively enable the graphical user interface without first re-activating the first touch-sensitive region 14 and the main display panel 18 and then navigating to the graphical user interface using the first touch-sensitive region 14. In some examples, the user input gesture may be a swipe input, a tap input, a multiple-tap input, a prolonged touch input or any combination of these input types. In some examples, the controller 10 may cause the second touch-sensitive region to become activated in response to detection of an occurrence of an event. The event may include, for example, receipt of a communication by the apparatus 1 or an internal event such as a calendar reminder. The graphical user interface may include information related to the event. The occurrence of the event may also be notified by the notification module 20. As such, the user may be alerted to the presence of the event without the main display being enabled. In some examples, the controller 10 may also respond to the user input gesture in respect of the second touch region 16 by enabling the touch sensitivity of the first touch-sensitive region 14.

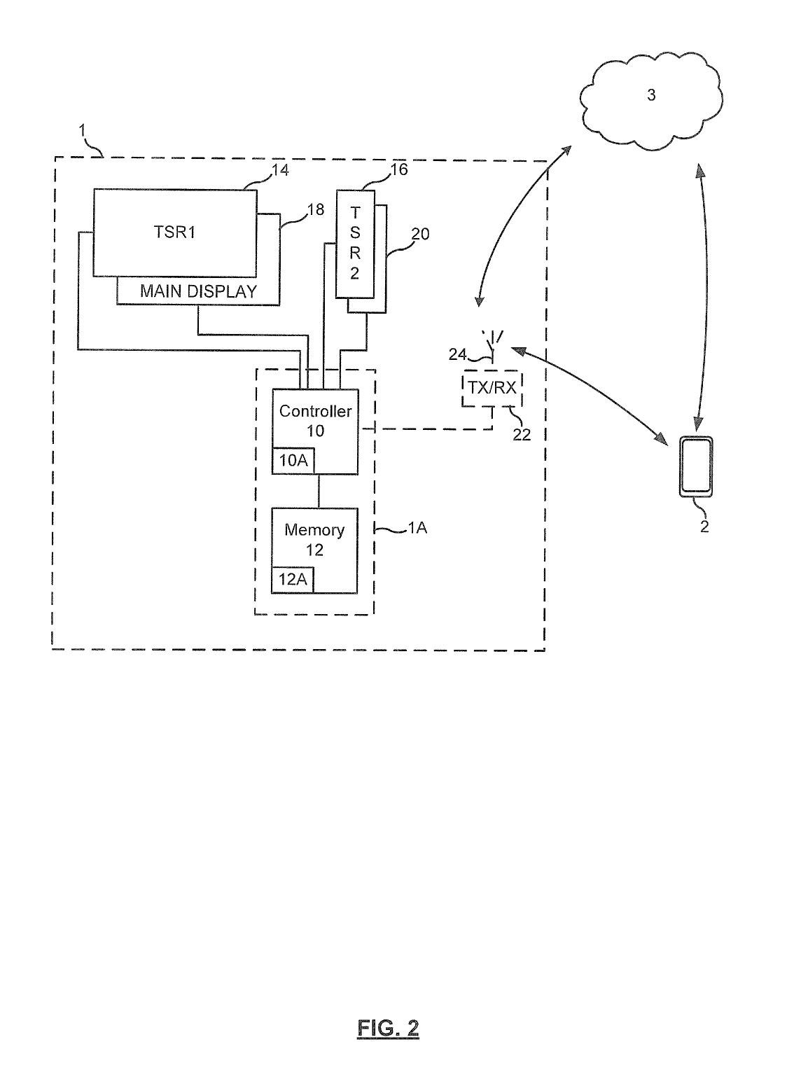

Other examples of operations that may be performed by the apparatus 1 will be understood from the following description of FIGS. 2 to 9.

FIG. 2 is an example of a system in which the apparatus 1 of FIG. 1 may be deployed. The system 100 comprises the apparatus 1, a remote device or apparatus 2 and a communication network 3. When deployed in a system 100 such as that of FIG. 2, the apparatus 1 may be referred to as a communication apparatus 1. The remote device or apparatus 2 may be, for example, a portable or stationary user terminal or server apparatus. The apparatus 1 may be configured to communicate with the remote device 2 via one or more wired or wireless communications protocols either directly or via a communications network 3. The remote apparatus 2 may comprise a similar or different type of apparatus to apparatus 1, and one or both apparatus 1, 2 may be portable or stationary in use. Examples of communications protocols via which the two apparatus 1, 2 are capable of communicating include but are not limited to communication protocols for a wireless or wired network, dependent on the connections capable of being established by both respective devices, and include, for example, communication protocols suitable for long-range networks including cellular wireless communications networks, wired or wireless local area networks (LAN or WLAN), short-range wireless communication protocols including device direct and ad-hoc networks, for example, to establish a near-field communications or Bluetooth link with another device, and communications protocols suitable for wired networks such as local area networks using Ethernet and similarly appropriate communications protocols, cable TV networks configured to provide data services, as well as the public switched telephone network (PSTN). The above communications capabilities can enable certain types of events which may trigger a notification on apparatus 1.

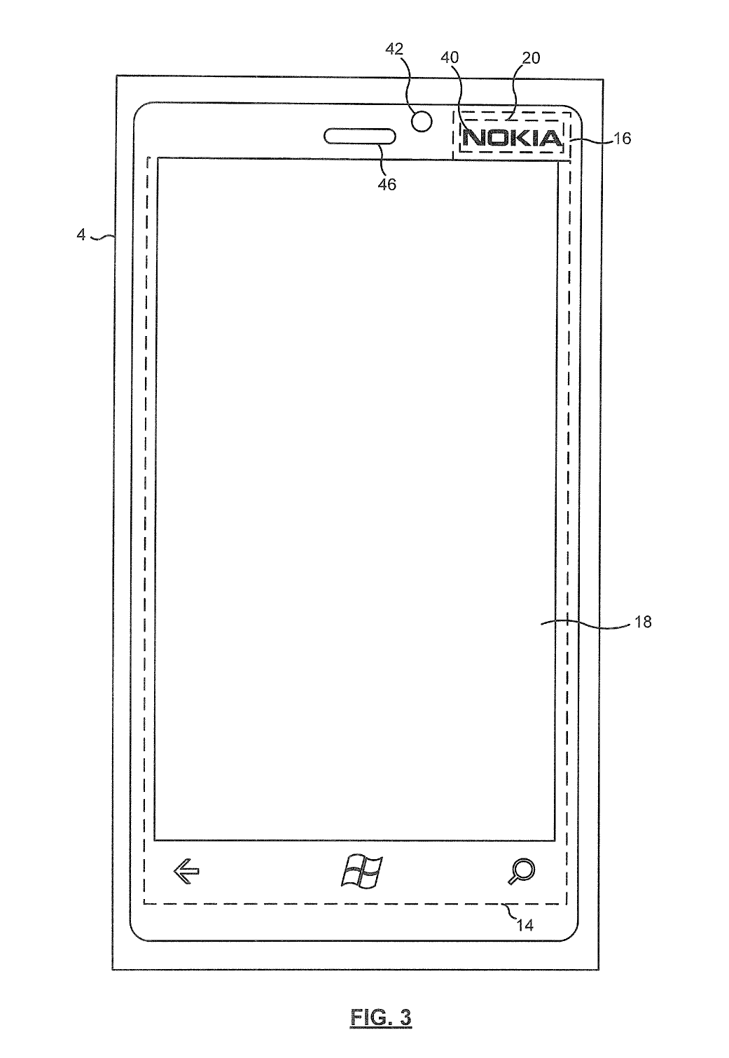

FIG. 3 shows an example of the apparatus 1 of FIG. 1 embodied in a device 4. In this example, the device 4 is portable and, more specifically, handheld. In this example, the device 4 is a mobile telephone. However, it will be appreciated that the device 4 may instead be, but is not limited to, a PDA, a tablet computer, a positioning module, a media player and a laptop. The term mobile telephone as used herein refers to any mobile apparatus capable of providing voice communications regardless of whether dedicated voice channels are used and as such includes mobile devices providing voice communications services over wireless data connections such as VoIP etc, and as such includes so called smart phone devices which are provided with a sufficiently powerful data processing component for supporting a plurality of applications running on the device, in addition to supporting more basic voice-communications functionality.

As can be seen from FIG. 3, the first touch-sensitive region 14, which is denoted by a dashed box marked by reference numeral 14, overlies the main display panel 18. As such, the first touch sensitive region 14 and the main display panel 18 form a touchscreen. In this example, the second touch-sensitive region 16, denoted by a dashed box marked by reference numeral 16 is located outside the perimeter of the main display panel 18. Put another way, the second touch-sensitive region 16 does not overlie the main display panel 18. Instead, in this example, the second touch-sensitive region 16 overlies the visual notification module 20, which is denoted by a dashed box marked by reference numeral 20.

In some examples, such as that of FIG. 3, the first and second touch-sensitive regions 14, 16 are provided adjacent to one another. More specifically, they are directly adjacent to one another. Put another way, an edge of the second touch-sensitive region 16 abuts an edge of the first touch-sensitive region 14. In this example, the second touch-sensitive region 16 abuts a top edge (when the device 4 is its normal orientation) of the first touch-sensitive region 14. However, it will be appreciated that the second touch-sensitive region 16 may be located in a different position relative to the first touch sensitive region 18. In some examples, such as that of FIG. 3, the first and second touch sensitive regions 14, 16 include co-planar surfaces.

The second touch-sensitive region 16 is smaller in area than is the first touch-sensitive region 14. As such, in examples in which both regions 14, 16 utilise capacitive or resistive touch sensing, when the touch sensitivities of the first and second regions 14, 16 are enabled, the second touch-sensitive region may utilise less power than the first touch-sensitive region 14. In other examples, such as when the second touch-sensitive region is provided by a light sensor or a proximity sensor, it may require less power to keep the light sensor or proximity sensor enabled than is required to keep the first touch sensitive region 14 (which may be capacitive) enabled.

In the example of FIG. 2, an image 40, in this case the manufacturer's logo, is provided within the second touch sensitive region 16. In some examples, the image 40 may be at least partially transparent such that the illumination from the visual notification module 20 is visible through the image 40. In this way, when visual notification module 20 is illuminated, it may appear that the image 40 is illuminated. In other examples, the image 40 may not be transparent, but an area surrounding the image may be transparent. In such examples, when the visual notification module is illuminated, the illumination may contrast with the image 40, which may be silhouetted. Placing the image 40 within the second touch-sensitive region 16 is an efficient use of the space on the front of the device 4. As such, other areas outside the main display 18 may be saved for other applications, such as a front facing camera 42, one or more proximity sensors, a light sensor, a speaker port 46, or one or more virtual touch-sensitive controls.

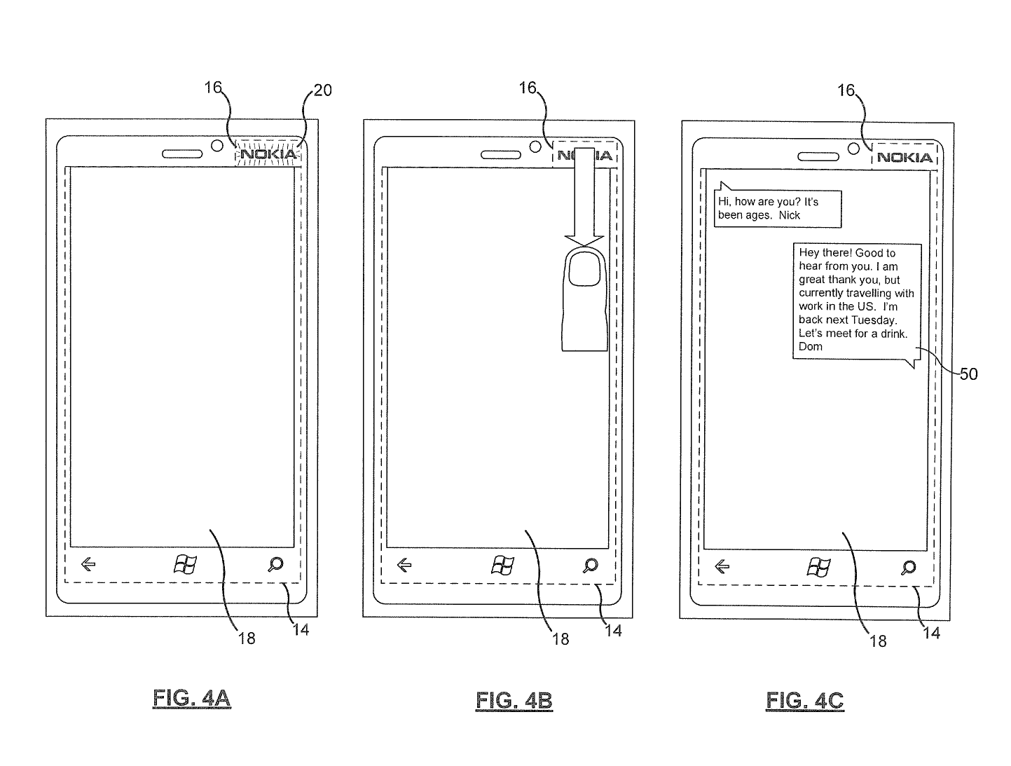

FIGS. 4A to 4C illustrate examples of operations that may be performed by the apparatus 1 of FIG. 1. In this example, the apparatus 1 is part of the device 4 of FIG. 3.

In FIG. 4A, the visual notification module 20, under the control of the controller 10 is, in response to the occurrence of an event, providing a visual notification to the user. In this example, the visual notification module 20 is illuminated, thereby to provide the notification to the user. As will be appreciated from FIG. 4C, in this example, the event is receipt of a communication (specifically, an SMS) from a remote apparatus 2. Although not visible in FIG. 4A, in addition to providing the visual notification, the apparatus 1 is configured such that the touch sensitivity of the second touch-sensitive region 16 currently is enabled and the touch-sensitivity of the first touch-sensitive region 14 is currently disabled. Also, the display panel 18 is disabled. As main display panel 18 and the first touch-sensitive region are both disabled, the touchscreen 18, 14 as a whole could be said to be in sleep mode. Put another way, the device could be said to be “locked”. In some embodiments, the main display panel and/or the first touch-sensitive region may not receive power.

Alternatively, if the electronic device is in a reduced power consumption mode of operation, the functionality of the user interface of the apparatus may be reduced so that the ability of the main display panel and/or the first touch sensitive region to process user input is diminished in some embodiments. For example, in some embodiments, when the user interface of the device is put into a partially enabled mode of operation, touch input which would otherwise be sensed and processed is no longer sensed or if sensed, not processed as touch-input in the way normal operational states of the user interface would support. Such operational states may be induced by low battery power reserve levels, for example, if a user has configured a power-saving operational profile for the apparatus, or if a user has manually triggered the apparatus to enter a so-called sleep state by causing the main display panel and/or first touch-sensitive region to be powered-off.

The apparatus 1 may be configured such that, immediately following the occurrence of the event, the controller 10 causes information regarding the event to be displayed on the main display panel 18 for consumption by the user. While the display panel 18 is enabled, the first touch-sensitive region 14 may also be enabled, such that the user can provide user inputs to the touch-sensitive first region 14, for example to access additional information regarding the event and/or to dismiss the event from the display. Following the expiry of a period which starts at the time of the occurrence of the event and in which the user does not interact with the apparatus 1 to access the additional information regarding the event, the controller 10 may cause the touch-sensitivity of the first touch-sensitive region 14 to be disabled and/or to be powered-off in some embodiments of the invention. In addition, the controller to may cause the main display panel 18 to be disabled. The controller 10 may be configured to cause the visual notification module 20 to provide a notification only after expiry of the period in which the additional information regarding the event is not accessed by the user. In other examples, the controller 10 may be configured to cause the visual notification to be provided immediately in response to detection of the occurrence of the event.

In some examples, if the main display panel 18 and first touch-sensitive region 14 are disabled when the occurrence of the event is detected, the controller 10 may maintain the main display panel 18 in a disabled state. In addition or instead, the controller 10 may maintain the first touch-sensitive region 14 in the disabled state.

In response to the detection of the event, the controller 10 is configured to cause the touch-sensitivity of the second touch-sensitive region 16 to be enabled. In some examples, the controller 10 may be configured to enable the second touch-sensitive region 16 in response to the event only when the touch-sensitivity of the first touch sensitive region 14 is disabled. As such, the second-touch sensitive region 16 may be enabled only following expiry of the period in which the additional information regarding the event is not accessed. If the first touch-sensitive region 14 is disabled when the event is detected and is not subsequently enabled, the second touch sensitive region 16 may be enabled immediately following detection of the event.

In FIG. 4B, the user provides a user input gesture in respect of the currently enabled second touch-sensitive region 16. In response to the user input gesture in respect of at least the second touch-sensitive region 16, the controller 10 is configured to cause a graphical user interface (GUI) 50 associated with the event to be displayed on the main display panel 18. When the main display panel was previously disabled, causing the GUI 50 to be displayed may also include enabling the main display 18. In some examples, the controller 10 may also be configured to respond to the user input in respect of the second touch-sensitive region 16 by enabling the touch-sensitivity of the first touch-sensitive region 14. In other examples, the touch sensitivity of the first touch-sensitive region 14 may not be enabled. The graphical user interface 50 includes information relating to the event. In examples in which the event is receipt of a text communication, the graphical user interface 50 may include text content from the received communication. In this example, as can be seen in FIG. 4C, the received communication is an SMS and, as such, the graphical user interface so includes the text content from the SMS. If multiple events are detected (for example, plural communications of different types have been received), the graphical user interface 50 may include information relating to at least two of the multiple events. In addition, the graphical user interface 50 may be configured to allow the user to provide a user input for accessing one or more additional user interfaces which are dedicated to a particular one of the events.

In the example of FIG. 4B, the user input gesture is a swipe input which moves from the second touch sensitive region 16 to the first touch-sensitive region 14. In examples such as this, the controller 10 may respond to the presence of the input within the second region 16 by enabling the touch sensitivity of the first touch-sensitive region 14. The controller 10 may subsequently respond to the dynamic input in the first region 14 (which is by this time enabled) by causing the graphical user interface 50 to be displayed. The enabling of the display 18 may be in response to either the input in respect of the second region 16 or the detected input in respect of the first region 14.

In examples in which a dynamic touch input from the second to first regions 16, 14 is required to cause the graphical user interface 50 to be displayed, if the dynamic input is not detected in the first region 14 subsequent to enabling the touch sensitivity of the first region 14, the touch sensitivity of the first region 14 may be re-disabled. If the display 18 was enabled in response to the input in respect of the second region 16, the display 18 may be re-disabled if a subsequent input is not detected in the first region 14. Also in examples in which a dynamic touch input from the second region 16 to the first region 14 is required to cause the graphical user interface 50 to be displayed, the graphical user interface 50 may be caused to be “dragged” onto the main display panel 18 by the part of the dynamic input in the first region 14.

In some examples, the controller to is operable to cause the GUI 50 to be displayed only in response to a prolonged input within the second region 16. The duration of the prolonged input may be, for example, 0.5 seconds or 1 second. The prolonged input may or may not be part of the above-described dynamic input moving from the second to first regions 16, 14. In examples in which the prolonged input is part of the dynamic input, the controller 10 may be configured to respond to the prolonged input in respect of the second region 16 by enabling the touch sensitivity of the first region 14 and optionally also enabling the display 18. The controller 10 may then respond to the dynamic input in respect of the first region 14 by enabling the display 18 (if it has not done so already) and by causing the graphical user interface 50 to be displayed. If the prolonged input is not required to be part of a dynamic input, the controller 10 may respond to the prolonged input in respect of the second region 16 by enabling the display 18 and by causing the graphical user interface 50 to be displayed on the display 18. The touch-sensitivity of the first region 14 may also be enabled in response to the prolonged input.

In examples in which a prolonged input in the second region 16 is required, the apparatus 1 may be configured to provide visual and/or non-visual feedback to the user to indicate that the duration has passed. For example, visual feedback may include the controller causing the graphical user interface 50 to be displayed on the main display panel 18. Non-visual feedback may include the controller 10 causing a vibration to be provided via a vibration module (not shown) or causing an audible sound to be provided via a speaker (not shown).

It will be understood that example embodiments described herein provide improved convenience for a user wishing to view information regarding events that have occurred since they last checked their device. More specifically, only a single user input may be required to allow the user to access information regarding events that have occurred, even when the touchscreen 14, 18 is disabled (or locked). In contrast in many prior art devices, when the device is locked, the user must first provide an input (e.g. a button press) to “wake-up” or reactivate the touchscreen. Next the user must, provide at least one other input (such as a dynamic touch input) to “unlock” the device. After this the user may be required to provide one or more further inputs to navigate to a particular graphical user interface which provides information relating to the event which has occurred. In addition, because the user is able to navigate more quickly to the graphical user interface 50 associated with the event (e.g. a received communication), the display 18 and the first touch-sensitive region 14 are activated for less time than they otherwise would be (while the user navigates to the desired GUI). As such, example embodiments may provide improved energy efficiency.

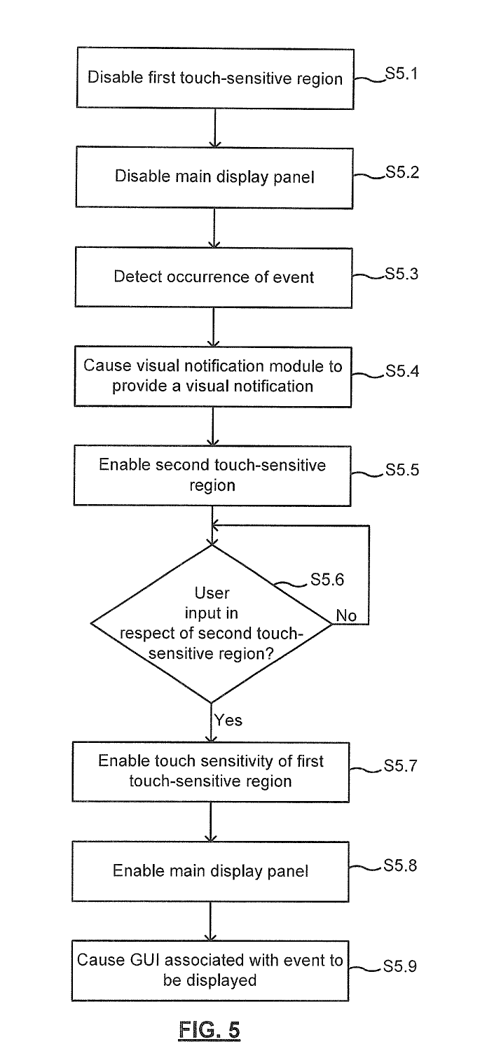

FIG. 5 is a flow chart illustrating examples of operations which may be performed by the apparatus of FIG. 1.

In step S5.1, the controller 10 causes the touch-sensitivity of the first touch sensitive region 14 to be disabled. As such, the first touch-sensitive region is temporarily unable to detect inputs provided thereto. In this state, the touch screen could be said to be locked.

In step S5.2, the controller 10 causes the main display panel 18 to be disabled. In some examples, following steps S50.1 and S50.2, the touchscreen 14, 18 of the apparatus 1 could be said to be in sleep mode or powered off if the sleep state is differently powered.

In step S5.3, the controller 10 detects the occurrence of an event. The event may be internal to the apparatus. As such the event may relate to the state of the apparatus or of a software application being executed by the apparatus. Additionally or alternatively, the event may be receipt of a communication from a remote device or apparatus 2. The communication may be, for example, a telephone call, a voicemail, an email, an SMS, an MMS or an application message or notification received from a server.

In step S50.4, in response to the detection of the occurrence of the event, the controller causes the visual notification module 20 to provide a visual notification to the user. Step S5.4 may include the controller 10 selecting the colour of the notification to be provided to the user based on the type of the event. If the event detected in step S5.3 is not the first event to have occurred since the user last viewed information regarding received events, step S5.4 may comprise changing the colour emitted by the notification module 20 to a colour which indicates the user that multiple events of different types have occurred.

In step S5.5, in response to the detection of the occurrence of the event, the controller 10 enables the touch sensitivity of the second touch-sensitive region 16. While enabled, the second touch-sensitive region 16 is operable to provide signals to the controller 10 that are indicative of user inputs provided to the second region 16.

Next, in step S50.6, the controller 10 determines if a user input has been provided at least in respect of the second touch-sensitive region 16. The user input may be any suitable type. In some examples, the user input must be a prolonged input. In other examples, the user input may be a tap or multiple-tap (e.g. double-tap) input. In other examples, the user input may be a swipe input traversing from the second region 16 to the first region 14. Although, various different gesture types have been described, it will be understood that any gesture type or combination of gesture types, at least part of which is in respect of the second touch-sensitive region 16 may be sufficient to cause a positive determination to be reached in step S50.6.

If in step S50.6, it is determined that the required user input in respect of the second touch-sensitive region 16 has been received, the operation proceeds to step S5.7. If it is determined that the required user input in respect of the second region 16 has not been received, the operation repeats step S5.6 until the required user input has been received.

In some embodiments, a type of gesture providing input to the second touch-sensitive region 16 is associated with a type of notification to be displayed. For example, even if a notification LED colour indicates, for example, a text message such as an SMS has been received, a user might have earlier missed a call and/or received and email. In one such example, a gesture comprising a double tap sequence on the first region 14 causes the latest type of notification to be displayed in the main display region 20, whereas another specified gesture such as a swipe in a first direction results in missed call information, whereas another gesture such as a swipe in the opposite direction results in missed calendar events being shown, whereas another input gesture or sequence of input gestures might result in a summary screen for unread emails, and another might show recent status updates for social network contacts, etc. etc.

In step S5.7, the controller 10 enables the touch-sensitivity of the first touch sensitive region 14.

In step S5.8, the controller 10 enables the display 18. In other words, the controller 10 “wakes-up” the display 18. This may be performed in response to the user input detected in step S5.7. Alternatively, as discussed above, this may be in response to a subsequent detection of a user input (e.g. a dynamic input) in respect of the now activated first touch-sensitive region 14.

In step S5.9, a graphical user interface 50 relating to the event detected in step S5.3 is caused to be displayed. As with step S50.8, this may be performed either in response to the user input detected in step S5.7 or in response to a user input detected in respect of the now-activated first region 14. In examples in which the event is receipt of a communication, the graphical user interface 50 may include information relating to the communication. In examples in which the communication contains viewable content, the graphical user interface 50 may include at least part of the viewable content contained in the communication.

It will of course be appreciated that the method illustrated in FIG. 5 is an example only. As such, in some examples, certain steps may be omitted and/or the order of certain steps may be altered. For example, as discussed above with reference to FIGS. 4A to 4C, the disabling of the touch-sensitivity of the first region 14 (step S50.1) and the disabling of the display 18 (step S50.2) may be performed after the event is detected (step S5.3). In some examples, the apparatus 1 may not include a visual notification module 20 and so step S5.4 may be omitted. In such examples, a notification of the event may be provided to the user in another way, for example, using a speaker, vibration module or the display 18. The location of the second touch-sensitive region 16 may, in these examples, be indicated by some permanently-visible logo or image. If the notification is provided on the display 18, it will be appreciated that step S50.2 may be omitted or the display 18 may be re-enabled after the occurrence of the event. In some examples, the touch-sensitivity of the first touch-sensitive region 14 may not be enabled in response to the user input gesture and, as such, step S5.7 may be omitted.

In some examples, whether or not the touch-sensitivity of the first touch sensitive region 14 is enabled may be dependent on the nature of the received user input gesture. As such, if a user input gesture of a first type (for example, but not limited, a single tap) is received in respect of the second touch-sensitive region 16, the controller 10 may cause the graphical user interface 50 to be displayed but may not enable the touch-sensitivity of the first touch-sensitive region 14. If, however, a user input gesture of a second type (for example, a swipe across the second touch-sensitive region 14, a double tap or a prolonged tap) is received in respect of the second touch-sensitive region 16, the controller 10 may respond by causing the graphical user interface 50 to be displayed and by enabling the touch-sensitivity of the first touch-sensitive region 14. In such, examples, the method may include the step of identifying a type of the user input gesture received in respect of the second touch-sensitive region. Step S5.7 may then be performed only if the gesture type matches a pre-specified gesture type.

In some examples, the controller 10 may be configured to respond to the user input gesture in respect of the second-touch sensitive region 16 by outputting, via e.g. loudspeaker (not shown), audible, verbal information regarding the event. For example, if the event is receipt of an SMS, the controller 10 may cause the SMS to be read aloud to the user. In some examples, this may be provided simultaneously with the display of the GUI 50.

FIG. 6 is a schematic illustration of an example of a construction of the visual notification module 20. In this example, the visual notification module 20 comprises an LED 20-1 and a light guide 20-2. In this example, the light guide 20-2 is substantially planar. The LED 20-1 is arranged relative to the light guide so as to emit light into the side of the light guide 20-2. The light guide 20-2 may be configured so as to diffuse the light throughout the light guide 20-2, thereby to provide the appearance that light guide 20-2 is glowing.

In the example of FIG. 6, the notification module 20 is located beneath a touch-sensitive panel 20-3, at least a part of an outer surface of which is the second touch-sensitive region 16. In this example, a main surface 20-2A of the light guide 20-2 is provided such that LED light passing out of the surface 20-2A passes through the touch sensitive panel 20-3. As such, the light is visible to the user. In some examples, at least part of the touch sensitive panel includes an image (see FIG. 2). The panel 20-3 may be configured such that light from the notification module 20 is able to pass through the image, but cannot pass through the area surrounding the image. Alternatively, the panel 20-3 may be configured such that light from the notification module 20 is able to pass through the areas surrounding the image, but cannot pass through the image itself.

In other examples, the notification module 20 may comprise a secondary display panel. In such examples, different images may be displayed on the secondary display panel to notify the user to the occurrence of different events.

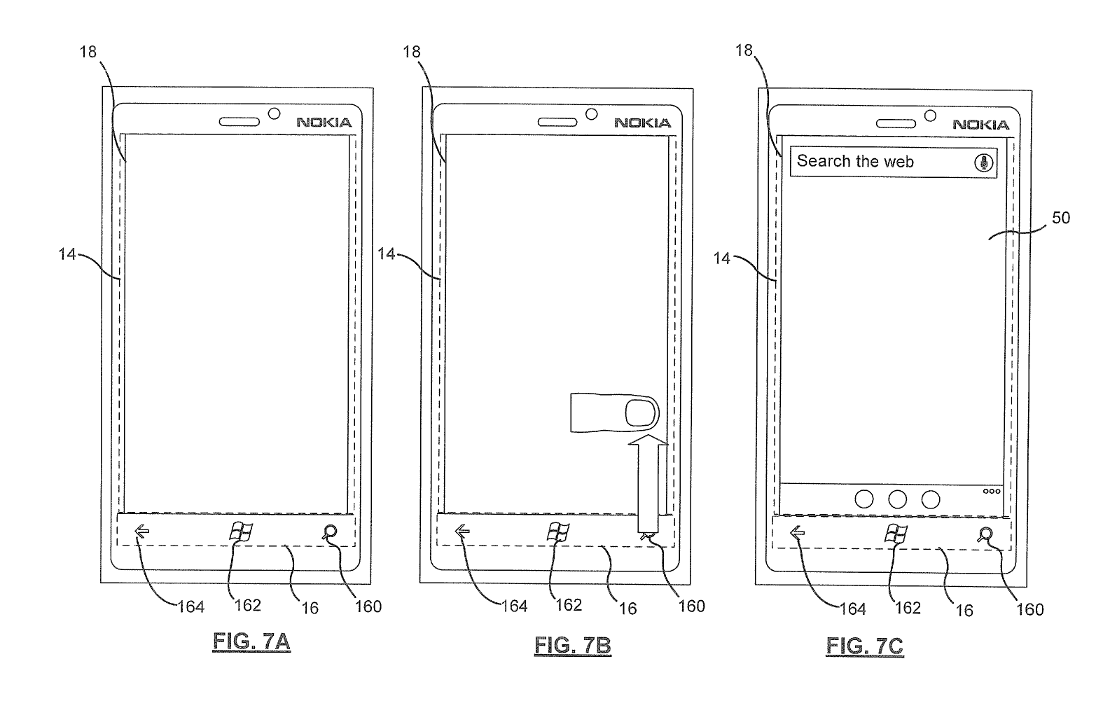

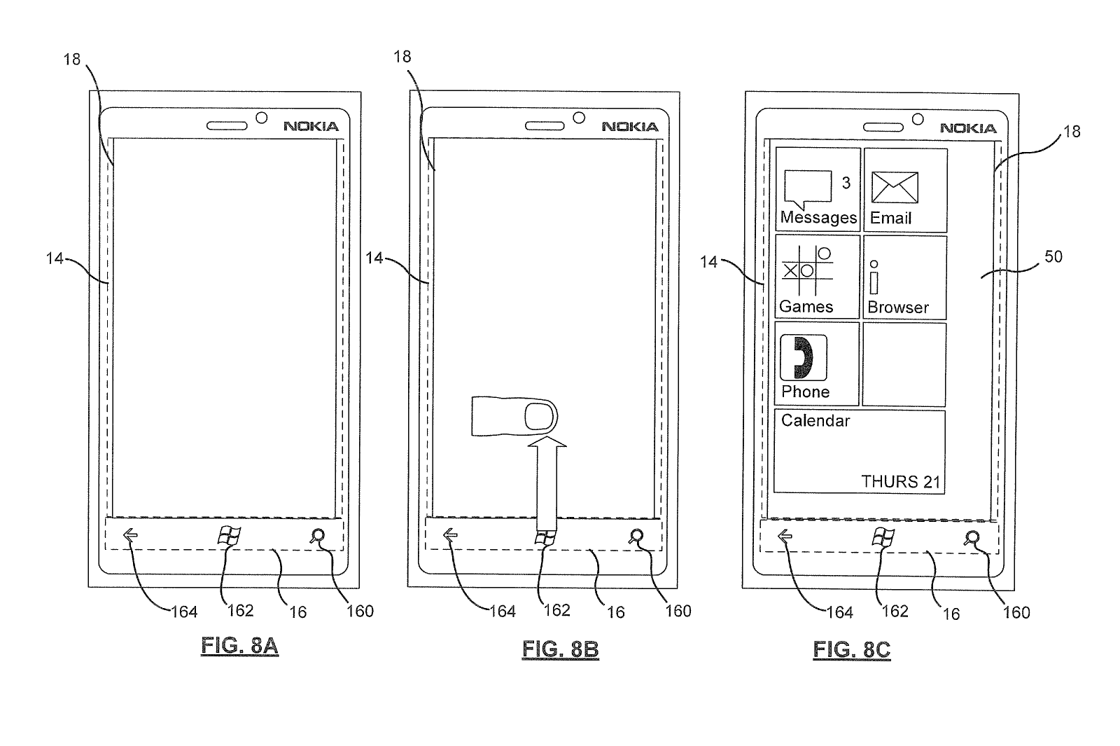

FIGS. 7A to 7C and 8A to 8C illustrate examples of operations that may be performed by the apparatus 1 of FIG. 1. In this example, the apparatus may or may not include the notification module 20. As can be seen from FIG. 7A to 8C, the apparatus is included in a device that is similar to that of FIG. 3. However, in these examples, the second touch-sensitive region 16 is not provided adjacent a top edge of the first touch-sensitive region 14, but is instead provided adjacent a bottom edge of the first touch-sensitive region 14. As with the example of FIG. 3, the second touch-sensitive region 16 is located outside the perimeter of the main display 18. The second touch sensitive region 16 may include a plurality of indicators 160, 162, 164 provided at different locations within the second touch sensitive region 16. When the device is fully unlocked (i.e. the first touch sensitive region 16 and the display 18 are both enabled), these indicators 160, 162, 164 may indicate the locations of touch-sensitive controls, selection of which causes particular actions to occur.

In FIGS. 7A and 8A, the apparatus 1 is configured such that the first touch-sensitive region is deactivated (i.e. is not sensitive to touch inputs). In addition, the main display 18 is disabled (although this may not always be the case). The second touch-sensitive region 16 is activated.

In FIGS. 7B and 8B, the user provides a user input gesture in respect of the second touch-sensitive region 16. In the example of FIGS. 7B and 8B, the user input gesture is a swipe input moving from the second touch-sensitive region 16 to the first touch-sensitive region 14. However, it will be appreciated that the user input gesture may be of any suitable type (such as but not limited to the types discussed above).

In response to the user input gesture in respect of the second touch-sensitive region 16, the controller 10 causes a graphical user interface 50 to be displayed (as can be seen in respect of FIGS. 7C and 8C). In addition, the controller 10 may be configured to determine a location within the second touch-sensitive region 16 in respect of which the user input gesture was received. The specific graphical user input 50 that is caused to be displayed may be selected from a plurality of GUIs based on the determined location. As such, if the determined location corresponds to a first reference location, the controller 10 may respond by causing a first GUI, which corresponds to the first reference location, to be displayed. If the determined location corresponds to the second reference location, the controller 10 may respond by causing a second GUI, which corresponds to the second reference location, to be displayed. This can be seen from FIGS. 7B and 7C and 8B and 8C in which user input gestures starting at different locations within the second region cause different GUIs 50 to be displayed. In FIG. 7C, an Internet search user interface is caused to be displayed whereas, in FIG. 8C, a menu interface is caused to be displayed.

The reference locations may correspond to the locations of the indicators 160, 162, 164. For example, in FIG. 7B, the user input gesture starts at a location in the second region 16 which corresponds to location of a right-hand one of the indicators 160. In contrast, in FIG. 8B, the user input gesture starts at a location of a centre-most one of the indicators 162. The indicators 160, 162 may be representative of the GUI 50 that is caused to be displayed.

In some examples, such as those of FIGS. 7A to 7C, receipt of the user input gesture in respect of the second-touch sensitive region 16 causes, the touch-sensitivity of the first region to be activated. This allows the user immediately to interact with displayed GUI 50.

In some examples, such as where the user input gesture includes parts in respect of both touch-sensitive regions 16, 18, the controller 10 may respond to the initial part of the gesture that is within the second touch-sensitive region 16 by activating touch-sensitivity of the first touch-sensitive region 16. Example of such gestures are the swipe inputs of FIGS. 7B and 8B which traverse from the second touch-sensitive region 16 to the first touch-sensitive region 14. Subsequently, in response to determining that the user input gesture transitions from the second touch-sensitive region 16 to the first touch-sensitive region 14, the controller 10 may cause the GUI 50 to be displayed. In these examples, the controller 10 may require a specific user input gesture part in respect of the first touch sensitive region. For example, the swipe may be required to move a particular distance within the first region 14 (e.g. half way into the screen) or the gesture may be required to last for a particular duration within the first region 14. In other examples, the user input gesture may be entirely in respect of the second touch-sensitive region 16.

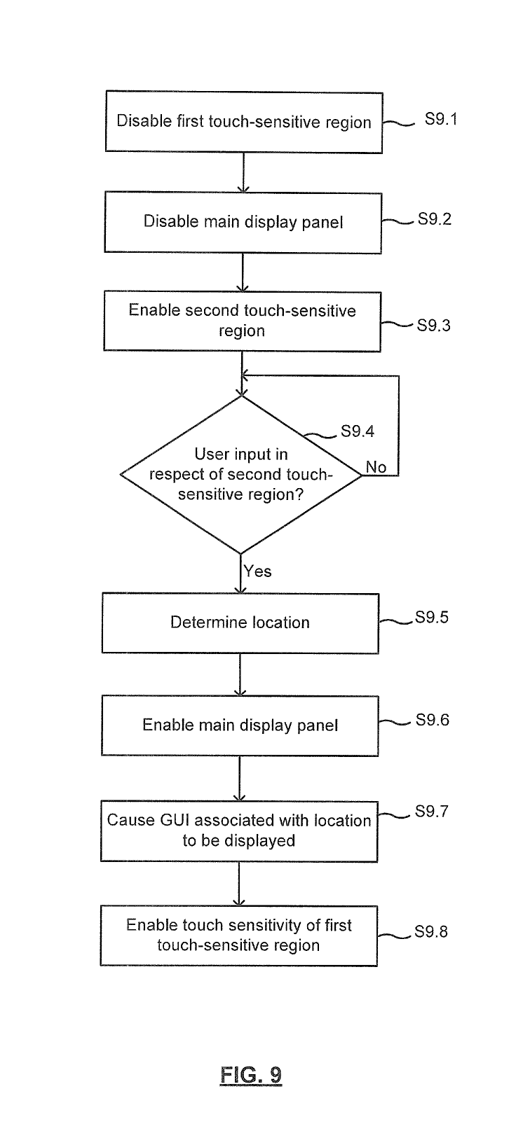

FIG. 9 is a flow chart illustrating an example of a method that may be performed by the apparatus of FIG. 1.

In step S9.1, the controller 10 causes the touch-sensitivity of the first touch sensitive region 14 to be disabled. As such, the first touch-sensitive region is temporarily unable to detect inputs provided thereto. In this state, the touch screen could be said to be locked.

In step S9.2, the controller 10 causes the main display panel 18 to be disabled. In some examples, following steps S9.1 and S9.2, the touchscreen 14, 18 of the apparatus 1 could be said to be in sleep mode or powered off if the sleep mode is differently powered.

In step S9.3, the controller 10 enables the touch sensitivity of the second touch-sensitive region 16. While enabled, the second touch-sensitive region 16 is operable to provide signals to the controller 10 that are indicative of user inputs provided to the second region 16. In some examples, the second touch-sensitive region 16 may be permanently enabled and in others it may be enabled only in response to the first touch-sensitive region 14 being disabled.

Next, in step S9.4, the controller 10 determines if a user input has been provided at least in respect of the second touch-sensitive region 16. The user input may be any suitable type (e.g. swipe, tap, double-tap or any combination of these).

If, in step S9.4, it is determined that a user input in respect of the second touch-sensitive region 16 has been received, the operation proceeds to step D9.5. If it is determined that the required user input in respect of the second region 16 has not been received, step S90.4 is repeated until it is determined that the required user input has been received.

In step S9.5, the controller 10 determines a location in the second region 16 in respect of which the user input gesture was received.

In step S9.6, the controller 10 enables the main display panel 18.

In step S9.7, the controller 10 selects or identifies, based on the determined location, a GUI from a plurality of GUIs and causes the selected GUI 50 to be displayed on the display panel 18.

Finally, in step S90.8, the controller 10 enables the touch sensitivity of the first touch-sensitive region 16.

As with the method of FIG. 5, it will of course be appreciated that the method illustrated in FIG. 9 is an example only. As such, in some examples, certain steps may be omitted and/or the order of certain steps may be altered. For example, step S9.8 of activating the first touch-sensitive region 14 may occur immediately after step S9.4 or step S9.5. In some examples, if the main display panel is already enabled when the user input gesture is received, steps S90.2 and S90.6 may be omitted. In some examples, only a single GUI may be associated with the second touch-sensitive region 16. In these examples, step S9.5 may be omitted. In other examples, the identification of the GUI in step S9.7 may not be based on location but may instead be based on user input gesture type. For example, a double tap may correspond to a first GUI type and a swipe input may correspond to a second GUI type. In these examples, step S9.5 may be replaced by a step of determining the user input gesture type and step S90.6 may be replaced by a step of causing a GUI associated with the identified gesture type to be displayed.

Although the only graphical user interfaces 50 specifically described with reference to FIGS. 7C and 8C are a menu GUI and an Internet search GUI, it will be appreciated that any type of graphical user interface may be associated with a location within the second touch-sensitive region 16, or with a particular gesture type. For example, a user input gesture in respect of the left-most icon 164 on the device of FIG. 7A (which, in this example, is a “back” control) may cause a previously viewed (e.g. a most recently viewed) graphical user interface to be displayed.

It will of course be appreciated that the operations described with reference to FIGS. 3A to 6 and FIGS. 7A to 9 may not be exclusive of one another. As such, the apparatus 1 of FIG. 1 may be able to perform some or all the operations described herein. In such examples, the apparatus may comprise plural independently controllable second touch-sensitive regions 16 as well as an independently controllable first touch-sensitive region 14. For example, the apparatus may include one second touch sensitive 16 at a first location (e.g. adjacent a first part, such as the a top edge, of the first touch-sensitive region 14) and may include another touch sensitive region at a second, different location (e.g. adjacent a second part, such as the a bottom edge, of the first touch-sensitive region 14). The regions may be provided on opposite sides of the device, for example, if the main touch sensitive region 14 is provided at the front of the device, the second touch-sensitive region 16 may be provided on the back. One of the second touch-sensitive regions may be enabled only in response to the occurrence of an event. This second touch-sensitive region 16 may overlie a notification module 20. The other second touch-sensitive region 16 may always be enabled or may be enabled only in response to the first touch sensitive region 14 being disabled.

It should be realized that the foregoing embodiments should not be construed as limiting. Other variations and modifications will be apparent to persons skilled in the art upon reading the present application. Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

1. Apparatus comprising:
at least one processor; and
at least one memory, having computer-readable code stored thereon, the at least one memory and the computer program code being configured to, with the at least one processor, cause the apparatus:
to disable touch-sensitivity of a first touch-sensitive region;
to enable touch-sensitivity of a second touch-sensitive region; and
to be responsive to receipt, while the touch-sensitivity of the first touch-sensitive region is disabled, of a user input gesture, at least part of which is in respect of the second touch-sensitive region, to cause a graphical user interface to be displayed on a display panel,
wherein the first and second touch-sensitive regions are configured to detect at least one type of touch input gesture and are configured such that the touch-sensitivities of the first and second touch sensitive regions are independently controllable.

2. The apparatus of claim 1, the at least one memory and the computer program code being configured to, with the at least one processor, cause the apparatus:
to disable the display panel, wherein the user input gesture is initiated while the display panel is disabled.

3. The apparatus of claim 1, the at least one memory and the computer program code being configured to, with the at least one processor, cause the apparatus: to be responsive to the receipt of the user input gesture to enable the touch-sensitivity of the first touch-sensitive region.

4. The apparatus of claim 1, the at least one memory and the computer program code being configured to, with the at least one processor, cause the apparatus:
to be responsive to the receipt of the user input gesture to enable the touch-sensitivity of the first touch-sensitive region;
to determine a type of the user input gesture; and to enable the touch-sensitivity of the first touch-sensitive region only if the determined type matches a predefined type.

5. The apparatus of claim 1, wherein the graphical user interface is caused to be displayed on the display panel while the touch-sensitivity of the first touch-sensitive region is disabled.

6. The apparatus of claim 1, the at least one memory and the computer program code being configured to, with the at least one processor, cause the apparatus:
to enable the touch sensitivity of the second touch-sensitive region in response to the detection of an occurrence of an event,
wherein the event comprises receipt by the apparatus of a communication from a remote device,
wherein the graphical user interface is associated with the received communication and includes content contained in the received communication.

7-13. (canceled)

14. The apparatus of claim 1, the at least one memory and the computer program code being configured to, with the at least one processor, cause the apparatus: to determine a location within the second touch-sensitive region in respect of which the part of the user input gesture was received; and
to select the graphical user interface for display from a plurality of graphical user interfaces based on the determined location within the second touch-sensitive region.

15. The apparatus of claim 1, the at least one memory and the computer program code being configured to, with the at least one processor, cause the apparatus: to determine a type of the user input gesture; and
to select the graphical user interface for display from a plurality of graphical user interfaces based on the determined type of the user input gesture.

16. The apparatus of claim 1, comprising:
the first touch-sensitive region; and
the second touch sensitive region.

17. The apparatus of claim 1, comprising:
the first touch-sensitive region; and
the second touch sensitive region,
wherein the first and second touch sensitive regions are regions of a continuous surface.

18. The apparatus of claim 1, comprising:
the first touch-sensitive region;
the second touch sensitive region,
wherein the first and second touch sensitive regions are regions of a continuous surface; and
the display panel,
wherein the first touch-sensitive region overlies the display panel and the second touch-sensitive region of the touch-sensitive panel is located outside a perimeter of the display panel.

19. The apparatus of claim 1,
the first touch-sensitive region;
the second touch sensitive region,
wherein the first and second touch sensitive regions are regions of a continuous surface;
the display panel,
wherein the first touch-sensitive region overlies the display panel and the second touch-sensitive region of the touch-sensitive panel is located outside a perimeter of the display panel; and
further comprising:
a visual notification module, wherein the second touch-sensitive region overlies the visual notification module.

20. The apparatus of claim 1, wherein the user input gesture comprises a swipe input, the swipe input moving from the second touch-sensitive region to the first touch sensitive region.

21. The apparatus of claim 1, comprising:
the first touch-sensitive region; and
the second touch sensitive region,
wherein the apparatus is a device and wherein the first and second touch-sensitive regions are provided on different faces of the device.

22. (canceled)

23. The apparatus of claim 1, wherein the user input gesture comprises a touch input in respect of the second touch-sensitive region, the touch input in respect of the second touch-sensitive region having a duration in excess of a threshold duration.

24-25. (canceled)

26. A method comprising:
disabling touch-sensitivity of a first touch-sensitive region;
enabling touch-sensitivity of a second touch-sensitive region, the first and second touch-sensitive regions being configured to detect at least one type of touch input gesture and being configured such that touch-sensitivities of the first and second touch sensitive regions are independently controllable; and
responding to receipt, while the touch-sensitivity of the first touch-sensitive region is disabled, of a user input gesture, at least part of which is in respect of the second touch-sensitive region, by causing a graphical user interface to be displayed on a display panel.

27. The method of claim 26, comprising disabling the display panel, wherein the user input gesture is initiated while the display panel is disabled.

28. The method of claim 26, comprising:
responding to the receipt of the user input gesture by enabling the touch-sensitivity of the first touch-sensitive region.

29-30. (canceled)

31. The method of claim 26, comprising:
enabling the touch sensitivity of the second touch-sensitive region in response to the detection of an occurrence of an event,
wherein the event comprises receipt by the apparatus of a communication from a remote device,
wherein the graphical user interface is associated with the received communication and includes content contained in the received communication.

32-44. (canceled)

45. At least one non-transitory computer-readable memory medium having computer-readable code stored thereon, the computer-readable code being configured to cause computing apparatus:
to disable touch-sensitivity of a first touch-sensitive region;
to enable touch-sensitivity of a second touch-sensitive region, the first and second touch-sensitive regions being configured to detect at least one type of touch input gesture and being configured such that touch-sensitivities of the first and second touch sensitive regions are independently controllable; and
to be responsive to receipt, while the touch-sensitivity of the first touch-sensitive region is disabled, of a user input gesture, at least part of which is in respect of the second touch-sensitive region, to cause a graphical user interface to be displayed on a display panel.

46-47. (canceled)
